(19) United States
(12) Patent Application Publication
(10) Pub. No.: US 2003/0198322 A1
(43) Pub. Date: Oct. 23, 2003

(54) Ring that matters

(76) Inventor: Danny Eugene White JR., Kenosha, WI (US)

Correspondence Address: LACASSE & ASSOCIATES, LLC, 1725 DUKE STREET, SUITE 650, ALEXANDRIA, VA, 22314, US

(21) Appl. No.: 10/124,239

(22) Filed: Apr. 18, 2002

(51) Int. Cl. H04M 1/64; H04M 1/00; H04M 3/00

(52) U.S. Cl. 379/88.19; 379/373.01

(57) ABSTRACT

An enhanced ringer service is described wherein subscribers are allowed to assign, via a menu, distinctive rings to telephone numbers of one or more callers. The enhanced ringer service is implemented via a subscriber interface server and a class 5 switch. Subscribers are able to interact, via a phone menu, with the customer user interface server and assign particular ringer types for incoming calls from one or more callers.

### BACKGROUND OF THE INVENTION

1. Field of Invention

The present invention relates generally to the field of telecommunications. More specifically, the present invention is related to caller identification.

2. Discussion of Prior Art

A popular device used in conjunction with telephones today is the caller identification unit. Such a unit provides the called party with the convenience of visually identifying, via an LCD display, the calling party's name/number. One problem associated with such caller identification units, is the requirement that the called party be physically near the unit to recognize the identity of the caller. Various solutions to this problem have been proposed in prior art patents and literature, however all require new/user-modified equipment/software.

FIG. 1 illustrates a prior art scenario wherein an enhanced caller ID unit 102 is used to identify the number associated with an incoming call (such as the number of calling party 1 106, calling party 2 108, or calling party n 110), and the identified number is compared against a list comprising stored telephone numbers and associated actions. Upon a successful match with an entry in the list, pre-defined actions are taken (as defined in the list). In a specific example, a list is maintained for one or more known telephone numbers, and the telecommunication device is instructed to generate a ring of a first type when an incoming call is from any of the telephone numbers in the list. On the other hand, if an incoming number cannot be matched to a number on the list, then the telecommunication device is instructed to generate a ring of a second ringer type to indicate to a user of a telephone (working in conjunction with the telecommunication device) that the caller is not on the maintained list.

FIG. 2 illustrates another scenario wherein an enhanced caller ID unit is used is used to assign a distinctive ring based upon the identity of the called party at the terminating end. For example, a list of known telephone numbers can be maintained for each member (Member 1 204, Member 2 206, and Member 3 208) of a household such that when an incoming call is detected for a specific household member, the telecommunication compares it against the list and generates a ring that corresponds to the household member the call was intended for. For example, the telecommunication device generates a first ringer type for a call that originates from Caller A 210 intended for Member 1 204; a second ringer type for a call that originates from Caller B 212 intended for Member 2 206; and a third ringer type for a call that originates from Caller C 214 intended for Member 3 208.

One common drawback associated with such enhancements to caller identification systems is the fact that such enhancements are implemented at the user's end, and thereby require users to upgrade their telecommunication equipment.

The following references provide a general understanding of prior art caller identification systems used in conjunction with a telecommunication device to generate varied ringer types based upon the identity of the callers.

The patent to Anderson (U.S. Pat. No. 5,995,603), assigned to AT&T Corp., provides for a telephone call screening device. Disclosed is a device for screening incoming phone calls, wherein a list of authorized callers' telephone numbers are maintained in the device. If the caller identification information for the incoming call is not in the list, a distinctive ring is generated for the call. It should be noted that this reference teaches away from the present invention as it appears to generate a distinctive ring only for unauthorized caller ID's.

The patent to Borland (U.S. Pat. No. 6,178,230 B1), assigned to Advanced Micro Devices, Inc., provides for a system and method for identifying a callee of an incoming telephone call. Disclosed is an improved telephone system that determines the identity of the callee of an incoming telephone call based upon a distinctive ring that is selected by one or more of the users. Information about the individual distinctive ring signals is stored in the memory inside the telephone, and a distinctive ring signal is generated corresponding to the identified callee of the incoming telephone call. It should be noted that this patent appears limited to a method for generating a distinctive ring signal corresponding to the person being called.

The patent to Bushnell (U.S. Pat. No. 6,289,084 B1), assigned to Lucent Technologies, Inc., provides for an apparatus, method, and system for personal telecommunication call screening and alerting. Disclosed is an automatic call screening and alerting apparatus, wherein caller identification information associated with an incoming call is compared with information in an affinity database and, in the instance a match is detected, a distinctive ring is generated. It should be noted that this patent does not appear to teach the assignment of distinctive rings for specific callers.

The published U.S. patent application to Shnier (2002/0,009,184 A1) provides for a call classification indication using sonic means. Disclosed is a method for classifying and screening incoming telephone calls based upon information, such as caller H), from a network provider.

One disadvantage associated with the prior art systems described above is that they require additional telecommunication equipment at the customer's end. For example, additional telephones, answering machines, and ring generators are required for implementing the systems of the above-mentioned patents.

Whatever the precise merits, features, and advantages of the above-cited references, none of them achieves or fulfills the purposes of the present invention.

### SUMMARY OF THE INVENTION

The present invention provides for a system and method that provides for an enhanced ringer service that allows subscribers to assign, via a menu, distinctive rings to telephone numbers of one or more callers. The enhanced ringer service is implemented in conjunction with a subscriber interface server and a class 5 switch, wherein the class 5 switch and the subscriber interface server are linked by a local exchange center. Subscribers are able to interact, via a phone menu, with the customer user interface server and assign particular ringer types for incoming calls from one or more callers.

By assigning distinctive rings to family members or friends, subscribers are able to identify who the incoming call is from without having to be near a caller ID unit. Additionally, when there is more than one person living in a household, the present invention's distinctive ring service can be used to associate different ringer types with callers to distinguish which one of the persons in the household the call was intended for.

It should be noted that since the ringer enhancements of the present invention are implemented via a class 5 switch, there is no requirement to upgrade any telecommunication equipment at the subscriber's end. Furthermore, subscribers don't require any additional equipment to communicate with the subscriber interface server, as they are able to change the distinctive ring associations via an interactive phone menu.

### BRIEF DESCRIPTION OF THE DRAWINGS

FIG. 1 illustrates a prior art enhancement to caller ID systems.

FIG. 2 illustrates another example of prior art enhancement to caller ID systems.

FIG. 3 illustrates the present invention's system providing for an enhanced ringer service.

FIGS. 4a and 4b collectively illustrate a method associated with the present invention.

FIG. 5 illustrates an example illustrating the functionality of the present invention's enhanced ringer service.

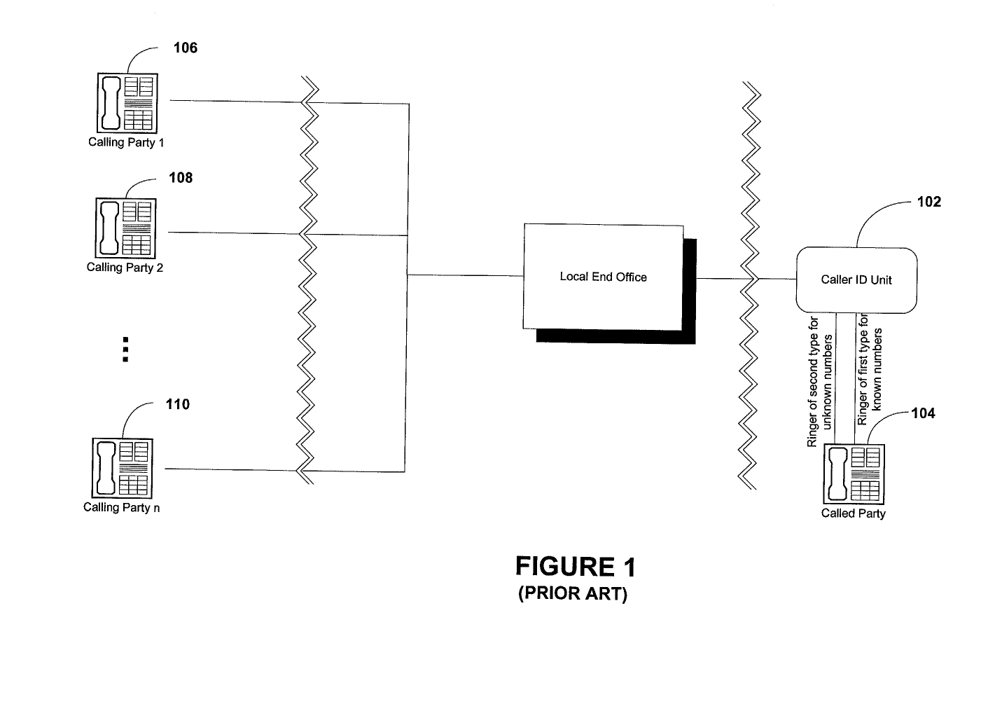

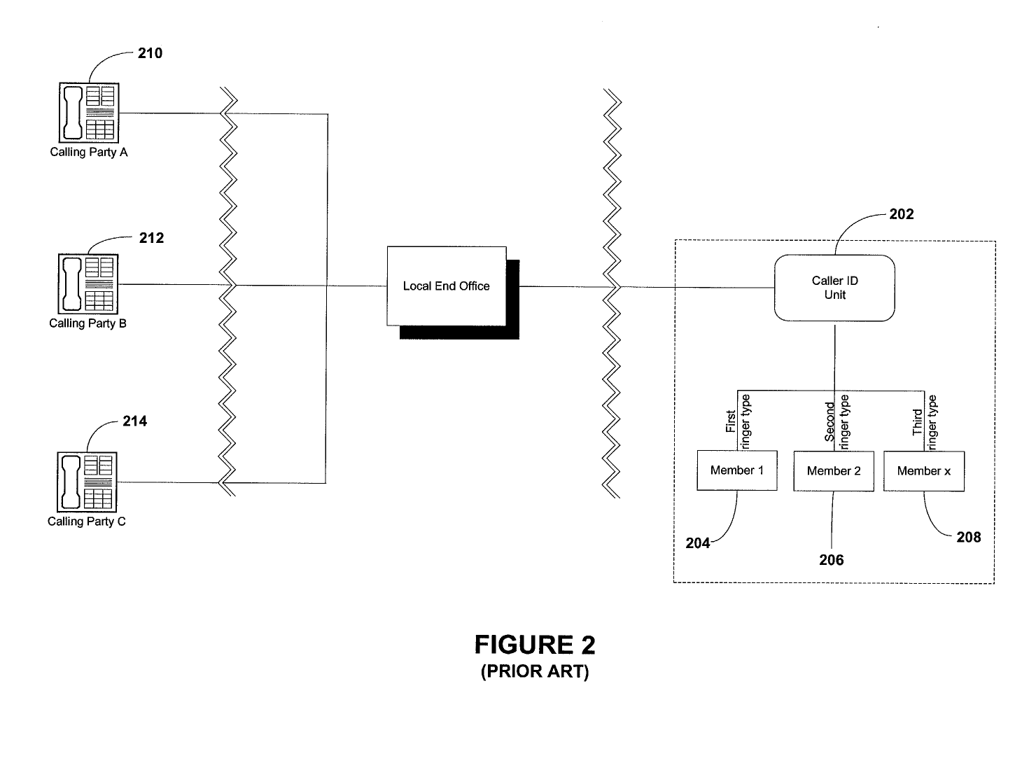

### DESCRIPTION OF THE PREFERRED EMBODIMENTS

While this invention is illustrated and described in a preferred embodiment, the invention may be produced in many different configurations, forms, and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

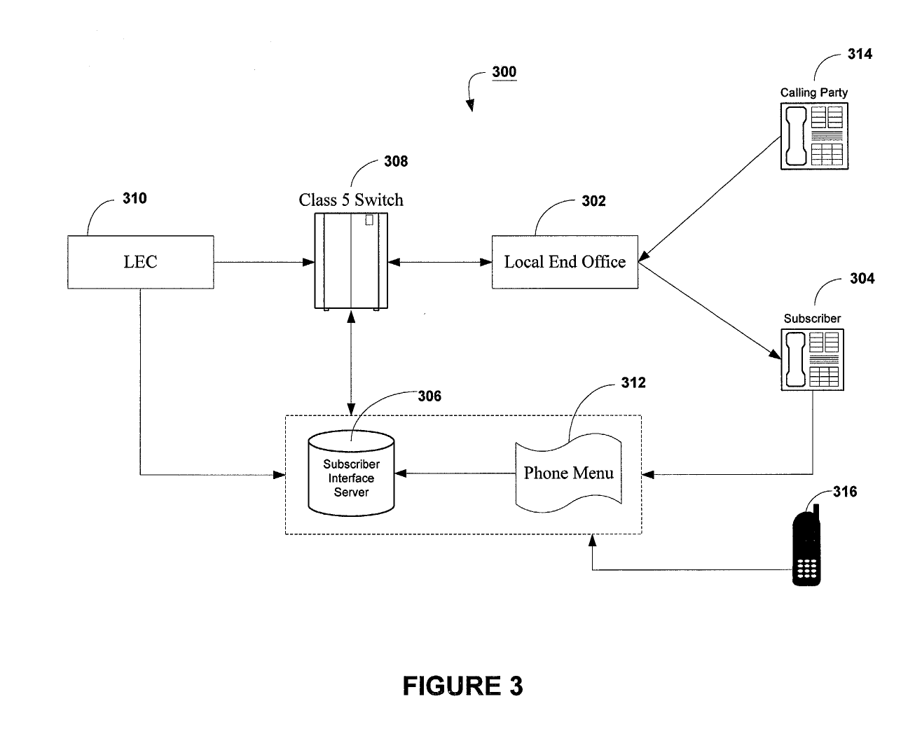

FIG. 3 illustrates the enhanced ringer (hereon ring that matters or RTM) system 300 associated with the present invention. The system provides for an enhanced ringer service implemented in conjunction with a subscriber interface server 306 and a class 5 switch 308. The class 5 switch 308 and the subscriber interface server 306 are linked by the local exchange center 310. In this scenario, a local end office 302 receives a request from a subscriber 304 (who subscribes to the present invention's RTM services) for enhancing his/her ringer services, wherein subscriber 304 identifies one or more callers to be associated with one or more distinctive ringer types. The subscriber 304 is able to interact, via a phone menu 312, with the customer user interface server 306 and assign particular ringer types for incoming calls from one or more callers.

In the instance of an incoming call from one of the identified callers 314, the subscriber interface server 306 and the class 5 switch 308 associates the caller 314 with a corresponding distinctive ringer type. Next, the class 5 switch 308, along with the local end office 302, renders the distinctive ringer type at the subscriber's end. Thus, the subscriber 304 is able to recognize the identity of the caller based on the ringer type that was previously set and does not have to be inconvenienced by rushing to the caller ID unit. Additionally, it should be noted that the above-mentioned enhancements to ringer types are accomplished without upgrading any telecommunication equipment (such as a telephone or caller ID unit) at the subscriber's end.

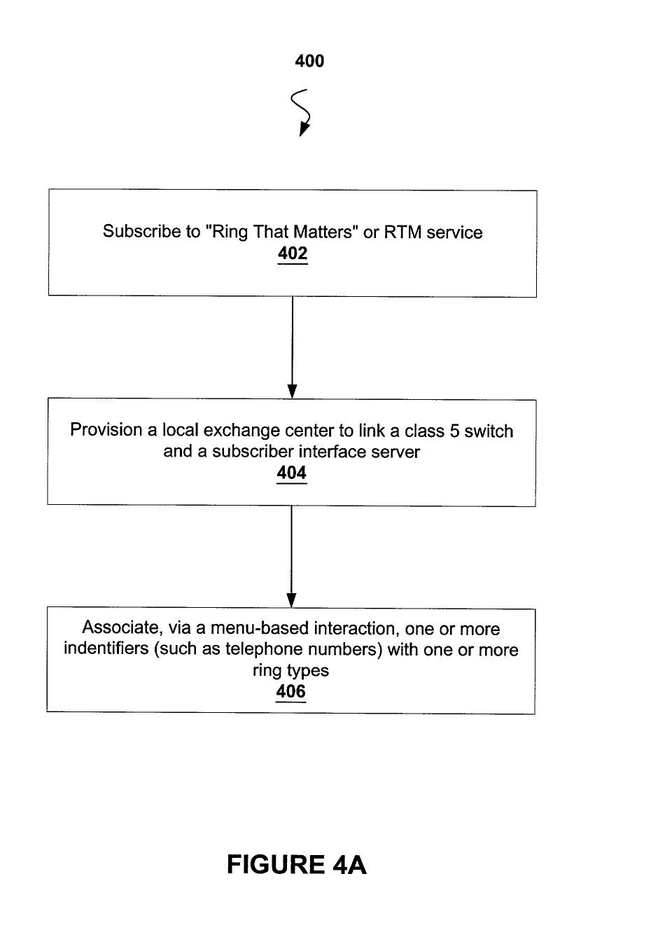

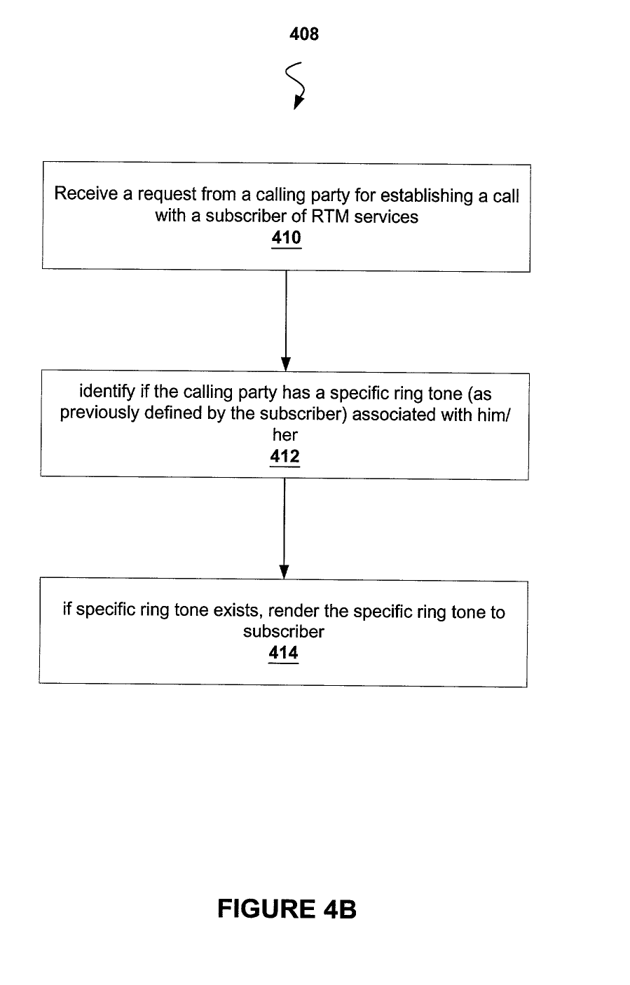

FIGS. 4a and 4b collectively illustrate a method associated with the present invention. FIG. 4a illustrates a method 400 for associating one or more callers with one or more ringer types. In step 402, a user subscribes to the RTM service. Next, in step 404, provisions are provided for in the local exchange center (LEC) to link the class 5 switch with a subscriber interface server. In step 406, the subscriber interacts with the subscriber interface server and associates one or more identifiers (such as telephone numbers corresponding to one or more callers) with one or more ringer types, wherein the association is facilitated via a menu-based interaction (e.g., via a phone menu) with the customer interface server. Thus, the interface helps change automatic number identifications (ANI's) at any given time via the menu. Additionally, the user interface also provides for local exchange center (LEC) provisioning.

It should be noted that although a specific example of a user interface is provided in the specification, other user interfaces such as a graphical user interface (GUI) are envisioned, and hence such limitations in the type of interface used should not be used to limit the scope of the present invention. Additionally, the present invention's enhanced ringer service can be implemented in other communication devices 316 such as, but not limited to: mobile phones, cellular phones, wireless-access-protocol (WAP) enabled cell phones, digital phones, or internet-based telecommunication systems. Thus, a cellular phone user can subscribe to the present invention's enhanced ringer service and manipulate ringer associations via a graphical user interface displayed on the cellular phone.

FIG. 4b illustrates a method 408 for associating a pre-set ringer type with an incoming caller. In step 410, a class 5 switch (with an enhancement feature for distinctive rings) receives a request from a calling party for establishing a communication session with a subscriber of the RTM services. Next, in step 412, the class 5 switch working in conjunction with a customer interface server identifies if the calling party has a specific ringer type (as previously defined by the subscriber) associated with him/her.

In the instance a specific ringer type exists for the caller, then the class 5 switch, in conjunction with the local end office, modifies, in step 414, the standard ringer type to the specific ringer type which is then rendered at the subscriber's end. Upon hearing the modified ringer type, subscribers are able to identify who the calling party is, and thereby avoid having to be physically present near a caller ID unit to identify the calling party. Additionally, as mentioned earlier, the user interface associated with the present invention is designed to allow customers (users) to change distinctive rings per automatic number identified. A specific example of the implementation of an aural interface is given below:

### EXAMPLE

A subscriber is expecting phone calls from party A. The subscriber calls a number (such as an 800 number, speed dial number, or Internet-based system) and interacts with a user interface that is driven by, for example, a phone menu. This GUT resides in a user interface server that interfaces with the class 5 switch.

a. Subscriber calls the 800 number.

b. User interface responds, “Hello, you have reached the Rings That Matter menu. Push or say ‘one’ for English, or push or say ‘two’ (recorded in Spanish) for Spanish.”

c. Subscriber pushes “1”.

d. User Interface responds, “Push ‘one’ to add, ‘two’ to delete, ‘three’ to modify, or ‘four’ to cancel.”

e. Subscriber pushes “1”.

f. User Interface responds, “Please put in the 10-digit telephone number starting with the area code first and then press ‘#’ when completed.”

g. Subscriber enters “123-XXX-XXXX”.

h. User Interface reads the 10-digit number back to the subscriber and responds, “Push ‘one’ if it is correct, or ‘two’ if it is incorrect.”

i. Subscriber pushes “1”.

j. User Interface responds, “You will have three types of rings: push ‘one’ for short rings, ‘two’ for long rings, and ‘three’ for short and long rings.”

k. Subscriber pushes “1”.

l. User Interface responds, “You have entered 123-XXX-XXXX with the ring type of ‘one’. If you wish to continue, press ‘1’; if not, hang up. The customer user interface that is on the user interface server will now update the class 5 switch.”

It should be noted that although the above example provides for a specific instance wherein subscribers are able to interact with the subscriber interface server via an aural phone menu, other modifications such as using a graphical phone menu are envisioned, and therefore such modifications should not be used to restrict the scope of the present invention.

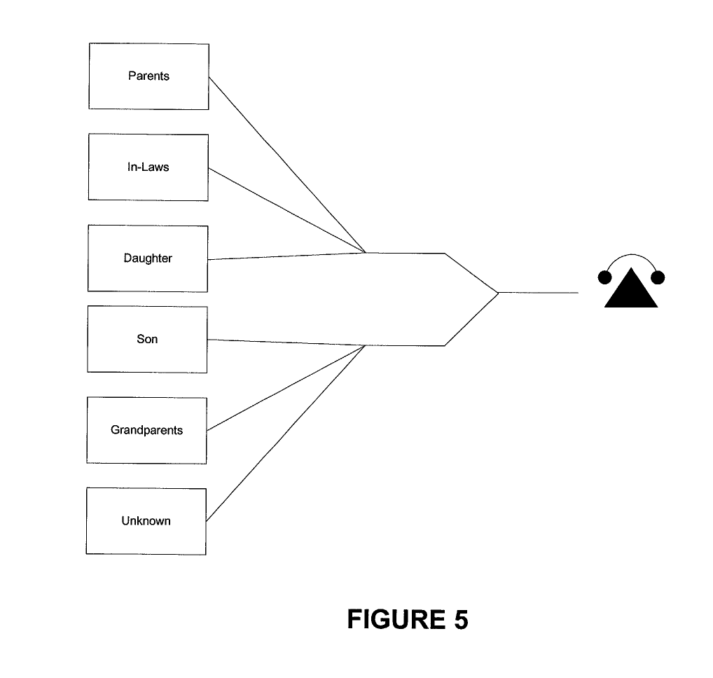

Thus, subscribers can assign a distinctive ring for each AIN, thereby allowing them to recognize the identity of the incoming caller without having to look at a caller ID unit. This is illustrated in FIG. 5, wherein a subscriber assigns distinctive rings to parents, in-laws, daughters, sons, grandparents, and unknown numbers. The subscriber is able to change the distinctive ring associated with each AIN via interacting with a menu (such as a telephone menu). Additionally, the subscriber is given the option of not forwarding calls from unknown telephone numbers. By assigning a distinctive ring to a family member and/or friends, subscribers are able to decide whether to answer the telephone or not. Typically, a telephone ring can be heard throughout the house; and with the distinctive rings of the present invention, subscribers are able to make more of an effort to answer the telephone if the distinctive ring is associated with someone they are interested in speaking with.

A simple scenario wherein the present invention's distinctive ring solution is helpful is when a subscriber is busy working on a project and is waiting for a call from caller A. In the instance of an incoming call, the subscriber does not have to worry about running to a caller ID unit to see if the call is from caller A as the subscriber is able to quickly identify, based upon a distinctive ring, who the caller is (as long as the subscriber has previously associated a distinctive ring for caller A in the subscriber interface server). In another scenario wherein there are one or more persons living in a household, distinctive rings can be associated with callers to distinguish which one of the persons in the household a call is intended for.

Furthermore, the present invention includes computer program code, which is stored on a storage medium and which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, and/or any other appropriate static or dynamic memory or data storage device.

Implemented in the computer readable program code are software modules for: provisioning the local exchange center (LEC) to tie the class 5 switch with a subscriber interface server; associating, via a menu-based interaction (e.g., a telephone menu), one or more identifiers (such as telephone numbers corresponding to one or more callers) with one or more ringer types; aiding in the reception of a request from a calling party for establishing a communication session with a subscriber of the RTM services; and identifying a specific ringer type (as previously defined by the subscriber) associated with the caller.

### CONCLUSION

A system and method has been shown in the above embodiments for the effective implementation of associating distinctive rings with one or more callers. While various preferred embodiments have been shown and described, it will be understood that there is no intent to limit the invention by such disclosure, but rather, it is intended to cover all modifications and alternate constructions falling within the spirit and scope of the invention as defined in the appended claims. For example, the present invention should not be limited by software/program, specific switching hardware, type of switch, number/location of subscriber interface server, type of telephone, type of ring, or number of telephone numbers that can be associated with one distinctive ring.

1. A system for associating distinctive rings with one or more callers, said system comprising:
a. a subscriber interface server storing, for each subscriber, information identifying one or more callers and pre-set ringer types associated with each of said callers, wherein said ringer types are pre-set via a menu-based interface available via said subscriber interface server; and
b. a telephony system communicating with said subscriber interface server and associating incoming callers with any pre-set ringer type and rendering any of said pre-set ringer type to said subscriber.

2. A system as per claim 1, wherein said telephony system is a class 5 switch.

3. A system as per claim 1, wherein said interface is a graphical user interface (GUI) capable of interfacing said subscriber interface server with telecommunication equipment associated with one or more subscribers.

4. A system as per claim 4, wherein said telecommunication equipment is any of the following: analog telephone, digital telephone, portable telephone, WAP-enabled telephone, cellular telephone, or Internet-based telephone.

5. A method, as implemented in a subscriber interface server, for associating distinctive ringer types with one or more callers, said subscriber interface server maintaining for each subscriber, one or more identifiers and associated pre-set ringer types, said method comprising the steps of:
a. identifying an incoming request for a communication session from a caller to a subscriber;
b. identifying, in said subscriber interface server, any pre-set ringer types associated with said caller; and
c. rendering any identified pre-set ringer type to said subscriber.

6. A method as per claim 5, wherein said pre-set ringer types are set via a interface capable of interfacing said subscriber interface server with telecommunication equipment associated with one or more subscribers.

7. A method as per claim 6, wherein said interface is a graphical user interface and the telecommunication equipment is any of the following: analog telephone, digital telephone, portable telephone, WAP-enabled telephone, cellular telephone, or Internet-based telephone.

8. A method as per claim 5, wherein said step of rendering any identified pre-set ringer type is done via a class 5 switch.

9. Computer readable program code for associating distinctive ringer types with one or more callers, said subscriber interface server maintaining for each subscriber, one or more identifiers and associated pre-set ringer types, said code comprising the steps of:
a. identifying an incoming request for a communication session from a caller to a subscriber;
b. identifying, in said subscriber interface server, any pre-set ringer types associated with said caller; and
c. rendering said pre-set ringer type to said subscriber.

10. A method, as implemented in a subscriber interface server, for associating distinctive ringer types with one or more callers, said method comprising the steps of:
a. in an associating mode:
i. establishing a communication link with a subscriber;
ii. receiving instructions via an interface for associating one or more telephone numbers with one or more ringer types; and
iii. associating said one or more telephone numbers with one or more ringer types, and
b. in a rendering mode:
i. identifying an incoming request for a communication session from a caller to said subscriber;
ii. identifying, in said subscriber interface server, any ringer types associated with said caller; and
iii. rendering said identified ringer type to said subscriber.

11. A method as per claim 10 wherein said interface is capable of interfacing said subscriber interface server with telecommunication equipment associated with one or more subscribers.

12. A method as per claim 11, wherein said interface is a graphical user interface and the telecommunication equipment is any of the following: analog telephone, digital telephone, portable telephone, WAP-enabled telephone, cellular telephone, or Internet-based telephone.

13. A method as per claim 10, wherein said step of rendering said identified ringer type is done via a class 5 switch.
